(19) United States
(12) Patent Application Publication
(10) Pub. No.: US 2009/0230579 A1
(43) Pub. Date: Sep. 17, 2009

(54) METHOD OF FABRICATING POLARIZER

(75) Inventors: Jan-Tian Lian, Keelung City (TW); Chien-Lung Tsou, Taoyuan County (TW); Chi-Neng Mo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/198,119

(22) Filed: Aug. 26, 2008

(30) Foreign Application Priority Data
Mar. 17, 2008 (TW) 97109330

(51) Int. Cl. B29D 11/00

(52) U.S. Cl. 264/1.34

(57) ABSTRACT

A method of fabricating a polarizer is provided. The method includes following steps. First, a polyvinyl alcohol (PVA) film is provided. A dyeing process is then performed on the PVA film by using an ultraviolet (UV) light as a dyeing assistant. Next, an iodine dyeing process is performed on the PVA film. Finally, a protection film is formed on an upper surface of the PVA film and a protection film is formed on a lower surface of the PVA film, so as to form the polarizer.

### CROSS-REFERENCE TO RELATED APPLICATION

This application claims the priority benefit of Taiwan application serial no. 97109330, filed on Mar. 17, 2008. The entirety of the above-mentioned patent application is hereby incorporated by reference herein and made a part of specification.

### BACKGROUND OF THE INVENTION

1. Field of the Invention

The present invention relates to a method of fabricating a polarizer, and more particularly to a method of fabricating a polarizer which is combining a drying process with an iodine dyeing process is performed.

2. Description of Related Art

As liquid crystal displays (LCDs) are widely applied to various products including mobile phones, portable computers, liquid crystal televisions, and so on. The required amount of polarizers used in the LCD is correspondingly increasing. Nevertheless, the polarizers need further improvement to enhance the degrees of polarization. In addition, the polarizers installed in different products comprising a global positioning system (GPS) must be characterized in satisfactory weather resistance, such as moisture repellence and heat resistance, so as to be adapted to different surroundings.

Currently, the polarizers can be divided into dye polarizers and iodine polarizers. The distinguish feature of dye polarizers is great weather resistance but unfavorable degrees of polarization. Therefore, the dye polarizers can only be applied to LCD panels requiring outstanding weather resistance but not high contrast, such as LCD projectors. By contrast, the iodine polarizers characterized by high degrees of polarization are frequently used by manufacturers of the LCD panels because such polarizers can be applied to LCD screens and LCD televisions. However, with unsatisfactory weather resistance, the iodine polarizers are not prone to be used in the LCD panels requiring outstanding weather resistance. FIG. 1 illustrates results of measuring an orthogonal transmission rate of a conventional iodine polarizer. As indicated in FIG. 1, the conventional iodine polarizer has extremely high orthogonal transmission rate at the blue and green light wavelength of 400 nm˜500 nm and at the red light wavelength of 680 nm˜780 nm. Hence, light leakage is apt to occur, and further reducing the contrast of a panel.

According to the pertinent art, a dyeing process and an iodine dyeing process are combined as an iodine hybrid process to fabricate the polarizer with great weather resistance and a favorable degree of polarization. However, as a molecular structure of a dyeing assistant used in the dyeing process is rather large, a subsequent step of bonding iodine ions and polyvinyl alcohol (PVA) molecules in the iodine dyeing process would be adversely affected when the dyeing assistant enters a PVA film, such that the iodine cannot have great dichroism, and that the degrees of polarization of the polarizers fabricated by said process are deteriorated.

### SUMMARY OF THE INVENTION

The present invention is directed to a method of fabricating a polarizer in which a dyeing process and an iodine dyeing process are both performed, so as to form the polarizer characterized by outstanding weather resistance and a high degree of polarization. Moreover, dark-state light leakage can also be prevented by applying said method.

The present invention provides a method of fabricating a polarizer. The method includes following steps. First, a polyvinyl alcohol (PVA) film is provided. A dyeing process is then performed on the PVA film by using an ultraviolet (UV) light as a dyeing assistant. Next, an iodine dyeing process is performed on the PVA film. Finally, a protection film is formed on an upper surface of the PVA film, and a protection film is formed on a lower surface of the PVA film, so as to form the polarizer.

According to an embodiment of the present invention, a swelling treatment is further performed on the PVA film after the PVA film is provided. Moreover, the PVA film can be extended when the swelling treatment is performed on the PVA film. According to an embodiment of the present invention, the method of fabricating the polarizer further includes extending the PVA film after the iodine dyeing process is performed on the PVA film.

According to an embodiment of the present invention, the PVA film can be extended when the dyeing process is performed on the PVA film.

According to an embodiment of the present invention, the PVA film can be extended when the iodine dyeing process is performed on the PVA film.

According to an embodiment of the present invention, a wavelength of the UV light approximately ranges from 400 nm to 450 nm.

According to an embodiment of the present invention, the two protection films are made of triacetyl cellulose (TAC).

In the method of fabricating the polarizer according to the present invention, the dyeing process and the iodine dyeing process are both performed, so as to form the polarizer characterized by outstanding weather resistance and a high degree of polarization. Moreover, the dark-state light leakage can also be mitigated by applying said method, and the contrast of the LCD panel of the polarizer can be enhanced.

To make the above and other objectives, features, and advantages of the present invention more comprehensible, several embodiments accompanied with figures are detailed as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates results of measuring an orthogonal transmission rate of a conventional iodine polarizer.

FIG. 2 is a schematic flowchart illustrating a process of fabricating a polarizer according to a first embodiment of the present invention.

FIG. 3 is a schematic flowchart illustrating a process of fabricating a polarizer according to a second embodiment of the present invention.

FIG. 4 is a schematic flowchart illustrating a process of fabricating a polarizer according to a third embodiment of the present invention.

FIG. 5 indicates results of measuring an orthogonal transmission rate of a conventional iodine polarizer and measuring an orthogonal transmission rate of a polarizer fabricated by performing an iodine hybrid process described in the first embodiment of the present invention.

FIG. 6 indicates results of measuring a degree of polarization of a conventional iodine polarizer and measuring a degree of polarization of a polarizer fabricated by performing the iodine hybrid process described in the first embodiment of the present invention.

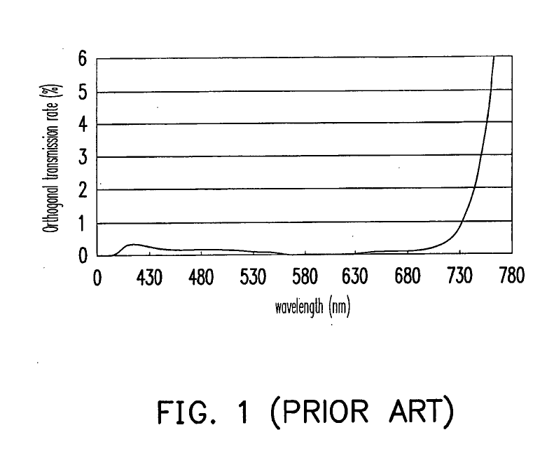

### DESCRIPTION OF EMBODIMENTS

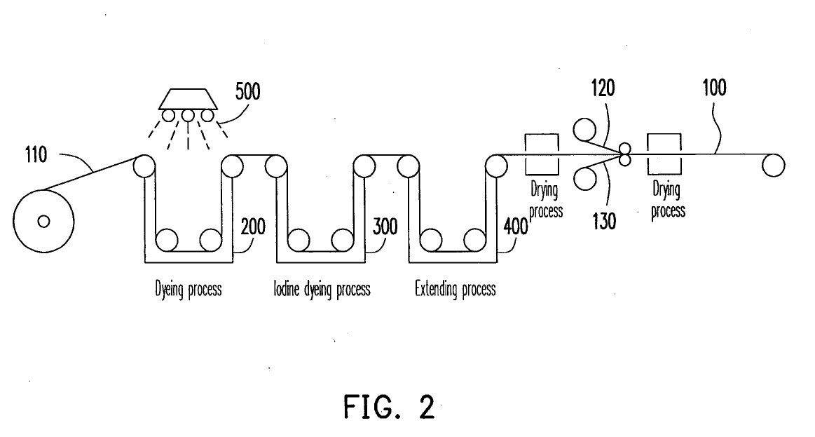

FIG. 2 is a schematic flowchart illustrating a process of fabricating a polarizer according to a first embodiment of the present invention. The polarizer of the present invention is fabricated by collectively performing a dyeing process and an iodine dyeing process, such that the polarizer can be characterized by great weather resistance of a dye polarizer and a favorable degree of polarization possessed by an iodine polarizer. As shown in FIG. 2, a PVA film 110 is first provided. The PVA film 110 is transported between different workstations by means of a plurality of rollers. Next, the PVA film 110 is transported to a first dyeing chamber 200 for performing a dyeing process on the PVA film 110. In particular, a UV light 500 acting as a dyeing assistant is applied to enhance a dyeing effectiveness of a dichroic dye when the dyeing process is performed on the PVA film 110. The UV light irradiation would result in photoisomerization of the dye molecules. The photoisomerization allows straight orientation of the dye molecules in PVA molecular chains, which is conducive to an improvement of the degree of polarization of the polarizer. In addition, a wavelength of the UV light 500 varies upon the properties of the dye employed in said method of fabricating the polarizer. In the present embodiment, a wavelength of the UV light 500 approximately ranges from 400 nm to 450 nm.

Next, with reference to FIG. 2, the PVA film 110 is transported to a second dyeing chamber 300 for performing an iodine dyeing process on the PVA film 110. Thereafter, the PVA film 110 is delivered to an extension chamber 400 for orientating the PVA molecular chain in a straight manner, thus giving rise to a favorable polarization effect. After that, the PVA film 110 is dried to reduce volatile substance contained therein. A protection film 120 and a protection film 130 are then respectively formed on an upper surface and a lower surface of the PVA film 110. In most cases, the protection films 120 and 130 are made of TAC. Thereafter, subsequent processes including a drying process and a cutting process are implemented on the PVA film 110 for forming the polarizer.

According to the pertinent art, as a molecular structure of the dyeing assistant used in the dyeing process is rather large, a step of bonding iodine ions and PVA molecules in the iodine dyeing process subsequently performed would be adversely affected when the dyeing assistant enters the PVA film 110, such that the iodine cannot have great dichroism, and that the degree of polarization of the polarizer fabricated by conducting the conventional method are deteriorated. By contrast, the UV light serving as the dyeing assistant is used in the dyeing process according to the present invention. Thereby, not only the conventional problem caused by using the dyeing assistant can be prevented, but also an iodine hybrid process can be implemented. As such, the polarizer fabricated by performing the aforesaid method of the present invention is characterized by outstanding weather resistance of the dye polarizer and a high degree of polarization possessed by the iodine polarizer.

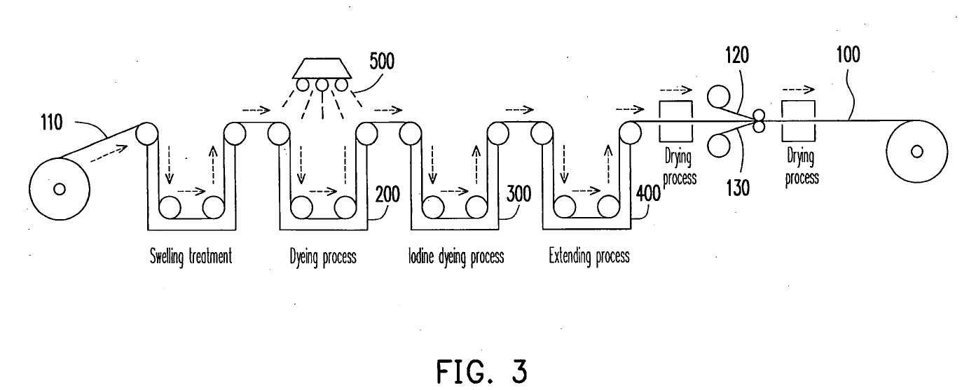

FIG. 3 is a schematic flowchart illustrating a process of fabricating a polarizer according to a second embodiment of the present invention. Referring to FIG. 3, the fabrication process of the polarizer fabricated in the second embodiment is approximately similar to that described in the first embodiment, while the difference therebetween lies in that a swelling treatment is first performed on the PVA film 110 in the second embodiment, and the dyeing process, the iodine dyeing process, the extending process, and other processes are subsequently performed for forming the polarizer as taught in the first embodiment. In the present embodiment, the PVA film 110 can be extended at the time the swelling treatment is performed on the PVA film 110. Thereby, the dye is more likely to be dispersed to the extended PVA film 110, and the PVA molecular chain can also be orientated in a relatively straight manner.

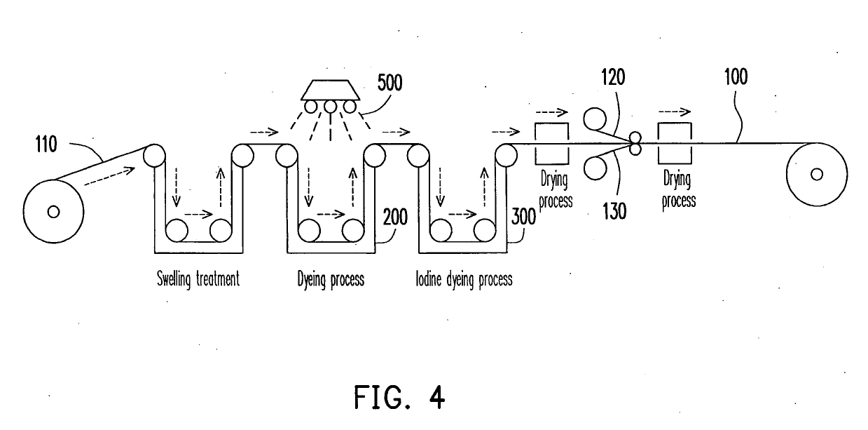

FIG. 4 is a schematic flowchart illustrating a process of fabricating a polarizer according to a third embodiment of the present invention. Referring to FIG. 4, the fabrication process fabricated in the third embodiment is approximately similar to that described in the second embodiment, while the difference therebetween lies in that the PVA film 110 is extended at the time the swelling treatment, the subsequent dyeing process, and the subsequent iodine dyeing process are performed on the PVA film 110 in the third embodiment, such that the PVA molecular chain can be straightly oriented to a better extent, and that the desirable polarization effect can be achieved. Here, no additional extending process is required by the dyed PVA film 110. As such, the dichroic substances are not separated out, and the polarization effect is not adversely affected.

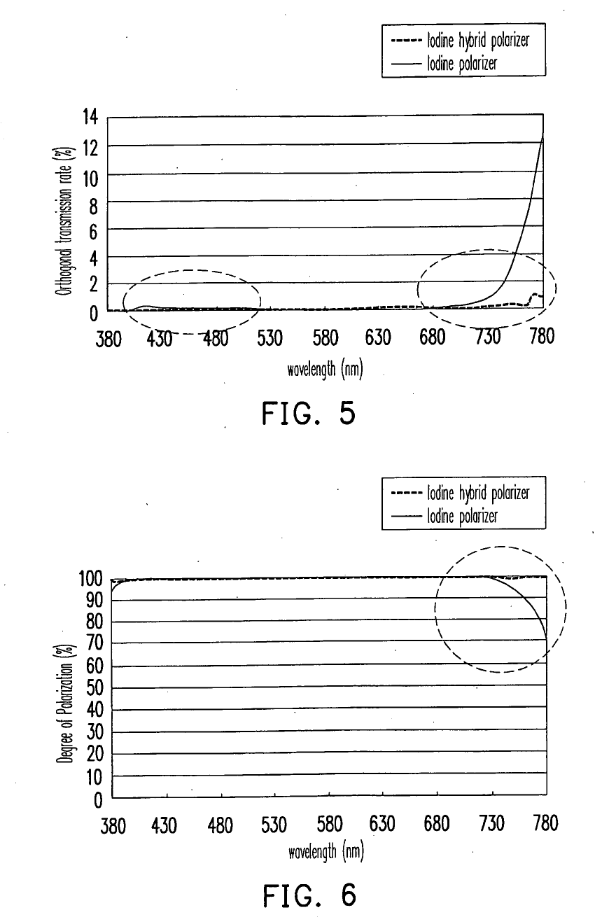

FIG. 5 indicates results of measuring an orthogonal transmission rate of a conventional iodine polarizer, and measuring an orthogonal transmission rate of a polarizer fabricated by performing an iodine hybrid process described in the first embodiment of the present invention. As shown in FIG. 5, the polarizer fabricated by performing the iodine hybrid process disclosed in the present invention has a lower orthogonal transmission rate at an entire wavelength of 380 nm˜780 nm than the conventional iodine polarizer does. Said difference in the orthogonal transmission rate is particularly apparent at the blue and the green light wavelength of 400 nm˜500 nm and at the red light wavelength of 680 nm˜780 nm. Thus, it is learned that the polarizer fabricated by performing the iodine hybrid process disclosed in the present invention can significantly reduce light leakage and further enhance the contrast of the LCD panel.

FIG. 6 indicates results of measuring a degree of polarization on a conventional iodine polarizer and measuring a degree of polarization on a polarizer fabricated by performing the iodine hybrid process described in the first embodiment of the present invention. As shown in FIG. 6, the degree of polarization of the polarizer that is fabricated by performing the iodine hybrid process disclosed in the present invention reaches 99% at the entire wavelength of 380 nm˜780 nm in comparison with the conventional iodine polarizer whose degrees of polarization are significantly reduced at the red light wavelength of 680 nm˜780 nm. Accordingly, the light leakage can be reduced to a significant degree.

To sum up, in the method of fabricating the polarizer according to the present invention, the dyeing process and the iodine dyeing process are both performed, so as to form the polarizer characterized by outstanding weather resistance of the dye polarizer and a high degree of polarization possessed by the iodine polarizer. Moreover, the dark-state light leakage can also be mitigated by applying said method, and the contrast of the LCD panel using the polarizer can be enhanced. The dyeing process of the present invention is performed by using the UV light as the dyeing assistant. Thus, since the dyeing assistant is not used in the dyeing process and does not enter the PVA film in the present invention, the step of bonding the iodine ions and the PVA molecules in the subsequent iodine dyeing process is not adversely affected, such that the degree of polarization of the polarizer fabricated by said process are not influenced.

Although the present invention has been disclosed by the above embodiments, they are not intended to limit the present invention. Anybody skilled in the art may make some modifications and alterations without departing from the spirit and scope of the present invention. Therefore, the protection range of the present invention falls in the appended claims.

What is claimed is:

1. A method of fabricating a polarizer, the method comprising:
providing a polyvinyl alcohol (PVA) film;
performing a dyeing process on the PVA film by using an ultraviolet (UV) light as a dyeing assistant;
performing an iodine dyeing process on the PVA film; and
forming a protection film on an upper surface of the PVA film and forming a protection film on a lower surface of the PVA film.

2. The method of fabricating the polarizer as claimed in claim 1, wherein a swelling treatment is further performed on the PVA film after the PVA film is provided.

3. The method of fabricating the polarizer as claimed in claim 2, wherein the PVA film is extended when the swelling treatment is performed on the PVA film.

4. The method of fabricating the polarizer as claimed in claim 1, further comprising extending the PVA film after the iodine dyeing process is performed on the PVA film.

5. The method of fabricating the polarizer as claimed in claim 1, wherein the PVA film is extended when the dyeing process is performed on the PVA film.

6. The method of fabricating the polarizer as claimed in claim 1, wherein the PVA film is extended when the iodine dyeing process is performed on the PVA film.

7. The method of fabricating the polarizer as claimed in claim 1, wherein a wavelength of the UV light approximately ranges from 400=m to 450 nm.

8. The method of fabricating the polarizer as claimed in claim 1, wherein the two protection films are made of triacetyl cellulose (TAC).
